(19) United States
(12) Patent Application Publication
(10) Pub. No.: US 2018/0068652 A1
(43) Pub. Date: Mar. 8, 2018

(54) APPARATUS AND METHOD FOR TRAINING A NEURAL NETWORK LANGUAGE MODEL, SPEECH RECOGNITION APPARATUS AND METHOD

(71) Applicant: Kabushiki Kaisha Toshiba, Minato-ku (JP)

(72) Inventors: Kun YONG, Beijing (CN); Pei DING, Beijing (CN); Yong HE, Beijing (CN); Huifeng ZHU, Beijing (CN); Jie HAO, Beijing (CN)

(73) Assignee: Kabushiki Kaisha Toshiba, Minato-ku (JP)

(21) Appl. No.: 15/352,901

(22) Filed: Nov. 16, 2016

(30) Foreign Application Priority Data
Sep. 5, 2016 (CN) 201610803962.X

(51) Int. Cl. G10L 15/06; G10L 15/197; G10L 15/16

(52) U.S. Cl. CPC G10L 15/063; G10L 15/16; G10L 15/197

(57) ABSTRACT

According to one embodiment, an apparatus trains a neural network language model. The apparatus includes a calculating unit and a training unit. The calculating unit calculates probabilities of n-gram entries based on a training corpus. The training unit trains the neural network language model based on the n-gram entries and the probabilities of the n-gram entries.

### CROSS-REFERENCE TO RELATED APPLICATION

This application is based upon and claims the benefit of priority from Chinese Patent Application No. 201610803962.X, filed on Sep. 5, 2016; the entire contents of which are incorporated herein by reference.

### FIELD

Embodiments relate to an apparatus for training a neural network language model, a method for training a neural network language model, a speech recognition apparatus and a speech recognition method.

### BACKGROUND

A speech recognition system commonly includes an acoustic model (AM) and a language model (LM). The acoustic model is used to represent the relationship between acoustic feature and phoneme units, while the language model is a probability distribution over sequences of words (word context), and speech recognition process is to obtain result with the highest score from weighted sum of probability scores of the two models.

In recent years, neural network language model (NN LM), as a novel method, has been introduced into speech recognition systems and greatly improves the speech recognition performance.

The training of the neural network language model is very time-consuming. In order to get a good model, it is necessary to use a large amount of training corpus and it takes much time to train the model.

In order to accelerate neural network model training speed, in the past, it is mainly solved by the hardware technology or distributed training.

The method using hardware technology, for example, uses the graphics card which is more suitable for matrix operations to replace CPU and can greatly accelerate the training speed.

Distributed training is to send the jobs which can be processed in parallel to multiple CPUs or GPUs to complete. Usually, neural network language model training is to calculate the error sum based on the batch training samples. Distributed training is to divide the batch training samples into several parts and assign each part to one CPU or GPU.

In traditional neural network language model training, acceleration of training speed mainly depends on the hardware technology and distributed training process involves frequent copy of the training samples and update of the model parameters, which needs to consider network bandwidth and the number of the parallel computing nodes. Moreover, for the neural network language model training, as to the input word given, each output is a specific word. But actually, even if the input word is fixed, the output should be multiple words, so the training objective is not consistent with the real distribution.

### BRIEF DESCRIPTION OF THE DRAWINGS

FIG. 1 is a flowchart of a method for training a neural network language model according to a first embodiment.

FIG. 2 is a flowchart of an example of the method for training a neural network language model according to the first embodiment.

FIG. 3 is a schematic diagram of a process of training a neural network language model according to the first embodiment.

FIG. 4 is a flowchart of a speech recognition method according to a second embodiment.

FIG. 5 is a block diagram of an apparatus for training a neural network language model according to a third embodiment.

FIG. 6 is a block diagram of an example of an apparatus for training a neural network language model according to the third embodiment.

FIG. 7 is a block diagram of a speech recognition apparatus according to a fourth embodiment.

### DETAILED DESCRIPTION

According to one embodiment, an apparatus trains a neural network language model. The apparatus includes a calculating unit and a training unit. The calculating unit calculates probabilities of n-gram entries based on a training corpus. The training unit trains the neural network language model based on the n-gram entries and the probabilities of the n-gram entries.

Below, preferred embodiments will be described in detail with reference to drawings.

### <A Method for Training a Neural Network Language Model>

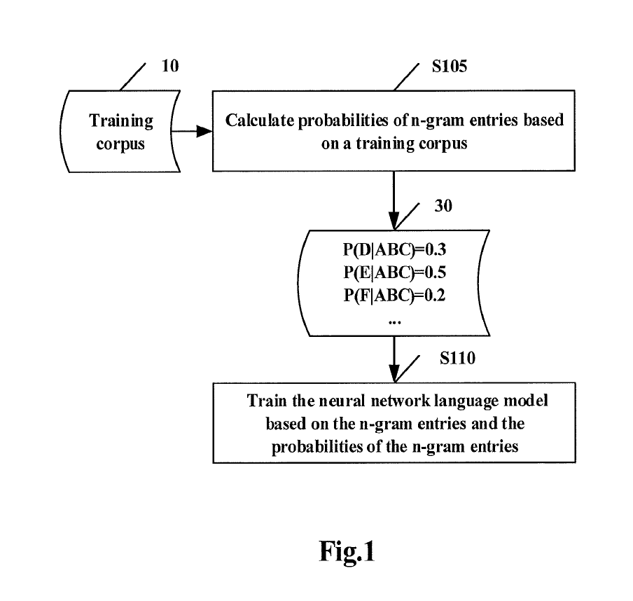

FIG. 1 is a flowchart of a method for training a neural network language model according to the first embodiment.

The method for training a neural network language model according to the first embodiment comprises: calculating probabilities of n-gram entries based on a training corpus; and training the neural network language model based on the n-gram entries and the probabilities of the n-gram entries.

As shown in FIG. 1, first, in step S105, probabilities of n-gram entries are calculated based on a training corpus 10.

In the first embodiment, the training corpus 10 is a corpus which has been word-segmented. The n-gram entry represents an n-gram word sequence. For example, when n is 4, the n-gram entry is “w1 w2 w3 w4”. The probability of an n-gram entry is a probability that the nth word occurs when the word sequence of the first n-1 words has been given. For example, when n is 4, the probability of 4-gram entry of “w1 w2 w3 w4” is a probability that the next word is w4 when the word sequence “w1 w2 w3” has been given, which is represented as P(w4|w1w2w3) usually.

The method for calculating probabilities of n-gram entries based on the training corpus 10 can be any method known by those skilled in the art, and the first embodiment has no limitation on this.

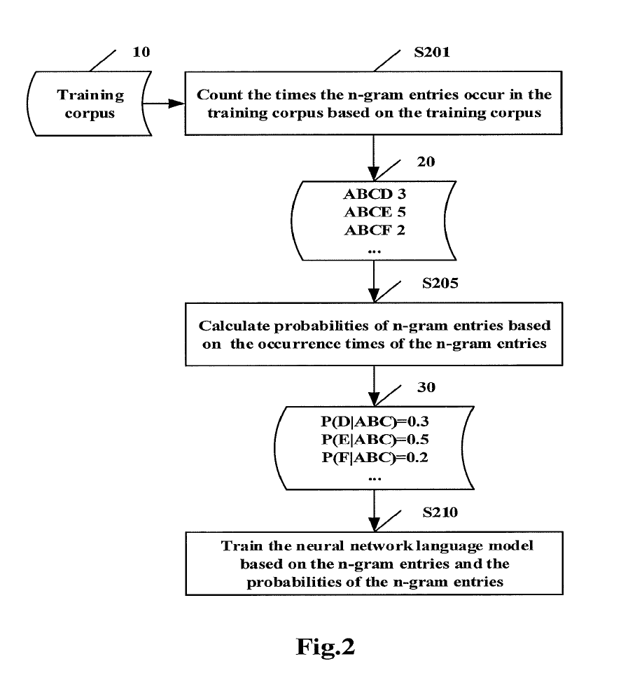

Next, an example of calculating probabilities of n-gram entries will be described in details with reference to FIG. 2. FIG. 2 is a flowchart of an example of the method for training a neural network language model according to the first embodiment.

As shown in FIG. 2, first, in step S201, the times the n-gram entries occur in the training corpus 10 are counted based on the training corpus 10. That is to say the times the n-gram entries occur in the training corpus 10 are counted and a count file 20 is obtained. In the count file 20, n-gram entries and occurrence times of the n-gram entries are recorded as below.
ABCD 3
ABCE 5
ABCF 2

Next, in step S205, the probabilities of the n-gram entries are calculated based on the occurrence times of the n-gram entries and a probability distribution file 30 is obtained. In the probability distribution file 30, n-gram entries and probabilities of the n-gram entries are recorded as below.
P(D|ABC)=0.3
P(E|ABC)=0.5
P(F|ABC)=0.2

The method for calculating the probabilities of the n-gram entries based on the count file 20, i.e. the method for converting the count file 20 into the probability distribution file 30 in step S205 will be described below.

First, the n-gram entries are grouped by inputs of the n-gram entries. The word sequence of the first n-1 words in the n-gram entry is an input of the neural network language model, which is “ABC” in the above example.

Next, the probabilities of the n-gram entries are obtained by normalizing the occurrence times of output words with respect to each group. In the above example, there are 3 n-gram entries in the group of which the input is “ABC”. The times of the n-gram entries with output word of “D”, “E” and “F” are 3, 5 and 2 respectively. The total times are 10. The probabilities of the 3 n-gram entries can be obtained by normalizing, which are 0.3, 0.5 and 0.2. The probability distribution file 30 can be obtained by normalizing with respect to each group.

Next, as shown in FIG. 1 and FIG. 2, in the step S110 or step S120, the neural network language model is trained based on the n-gram entries and the probabilities of the n-gram entries, i.e. the probability distribution file 30.

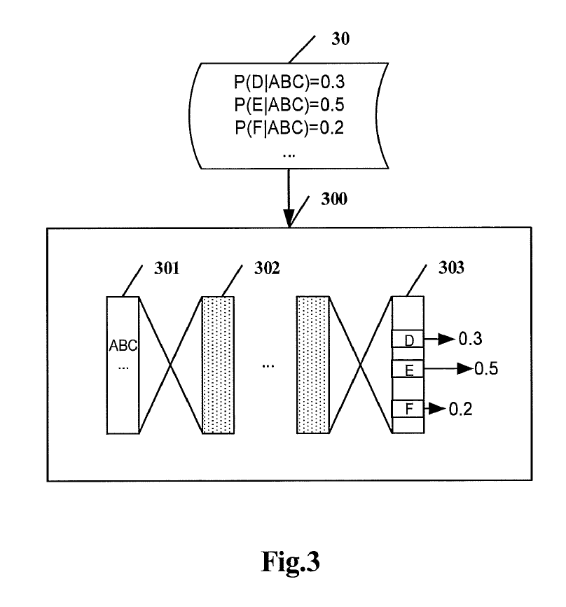

The process of training the neural network language model based on the probability distribution file 30 will be described with reference to FIG. 3 in details below. FIG. 3 is a schematic diagram of a process of training a neural network language model according to the first embodiment.

As shown in FIG. 3, the word sequence of the first n-1 words of the n-gram entry is inputted into the input layer 301 of the neural network language model 300, and the output words of “D”, “E” and “F” and the probabilities of 0.3, 0.5 and 0.2 thereof are inputted into the output layer 303 of the neural network language model 300 as a training objective. The neural network language model 300 is trained by adjusting a parameter of the neural network language model 300. As shown in FIG. 3, the neural network language model 300 also includes hidden layers 302.

In the first embodiment, preferably, the neural network language model 300 is trained based on a minimum cross-entropy rule. That is to say, the difference between the real output and the training objective is decreased gradually until the model is converged.

Through the method for training a neural network language model of the first embodiment, the original training corpus 10 is processed into the probability distribution file 30, the training speed of the model is up by training the model based on the probability distribution and the training becomes more efficient.

Moreover, through the method for training a neural network language model of the first embodiment, the model performance is improved since optimization of the training objective is not local but global, so the training objective is more reasonable and the accuracy of the classification is much higher.

Moreover, through the method for training a neural network language model of the first embodiment, implementation is easy and there is fewer modification for the model training process, only the input and output of training are modified and the final output of the model is not varied, so it is compatible with existing technology like distributed training.

Moreover, preferably, after the times the n-gram entries occur in the training corpus 10 are counted in step S201, the method further comprises a step of filtering an n-gram entry with an occurrence times which is lower than a pre-set threshold.

Through the method for training a neural network language model of the first embodiment, it is realized to compress the original training corpus by filtering n-gram entries with low occurrence times. Meanwhile, the noise of the training corpus is removed and the training speed of the model can be further up.

Moreover, preferably, after the probabilities of the n-gram entries are calculated in step S205, the method further comprises a step of filtering an n-gram entry based on an entropy rule.

Through the method for training a neural network language model of the first embodiment, the training speed of the model can be further up by filtering n-gram entries based on the entropy rule.

### <A Speech Recognition Method>

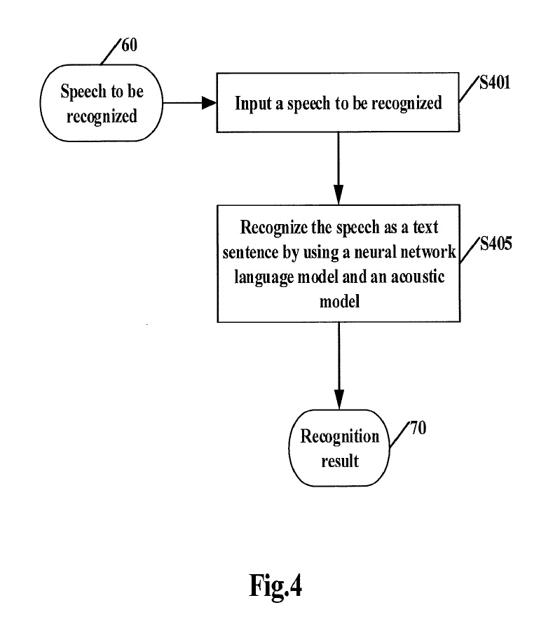

FIG. 4 is a flowchart of a speech recognition method according to a second embodiment under a same inventive concept. Next, this embodiment will be described in conjunction with that figure. For those same parts as the first embodiment, the description of which will be properly omitted.

The speech recognition method for the second embodiment comprises: inputting a speech to be recognized; and recognizing the speech as a text sentence by using a neural network language model trained by using the method of the first embodiment and an acoustic model.

As shown in FIG. 4, in step S401, a speech to be recognized is inputted. The speech to be recognized may be any speech and the embodiment has no limitation thereto.

Next, in step S405, the speech is recognized as a text sentence by using a neural network language model trained by the method for training the neural network language model and an acoustic model.

An acoustic model and a language model are needed during recognition of the speech. In the second embodiment, the language model is a neural network language model trained by the method for training the neural network language model, the acoustic model may be any acoustic model known in the art, which may be a neural network acoustic model or may be other type of acoustic model.

In the second embodiment, the method for recognizing a speech to be recognized by using an acoustic model and a neural network language model is any method known in the art, which will not be described herein for brevity.

Through the above speech recognition method, the accuracy of the speech recognition can be increased by using the neural network language model trained by using the above-mentioned method.

### <An Apparatus for Training a Neural Network Language Model>

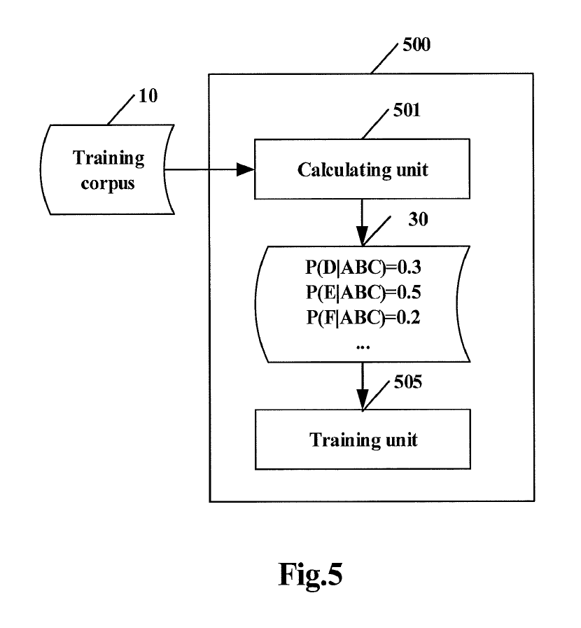

FIG. 5 is a block diagram of an apparatus for training a neural network language model according to a third embodiment under a same inventive concept. Next, this embodiment will be described in conjunction with that figure. For those same parts as the above embodiments, the description of which will be properly omitted.

As shown in FIG. 5, the apparatus 500 for training a neural network language model of the third embodiment comprises: a calculating unit 501 that calculates probabilities of n-gram entries based on a training corpus 10; and a training unit 505 that trains the neural network language model based on the n-gram entries and the probabilities of the n-gram entries.

In the third embodiment, the training corpus 10 is a corpus which has been word-segmented. The n-gram entry represents an n-gram word sequence. For example, when n is 4, the n-gram entry is “w1 w2 w3 w4”. The probability of an n-gram entry is a probability that the nth word occurs when the word sequence of the first n-1 words has been known. For example, when n is 4, the probability of 4-gram entry of “w1 w2 w3 w4” is a probability that the next word is w4 when the word sequence “w1 w2 w3” has been given, which is represented as P(w4|w1w2w3) usually.

The method for the calculating unit 501 for calculating probabilities of n-gram entries based on the training corpus 10 can be any method known by those skilled in the art, and the third embodiment has no limitation on this.

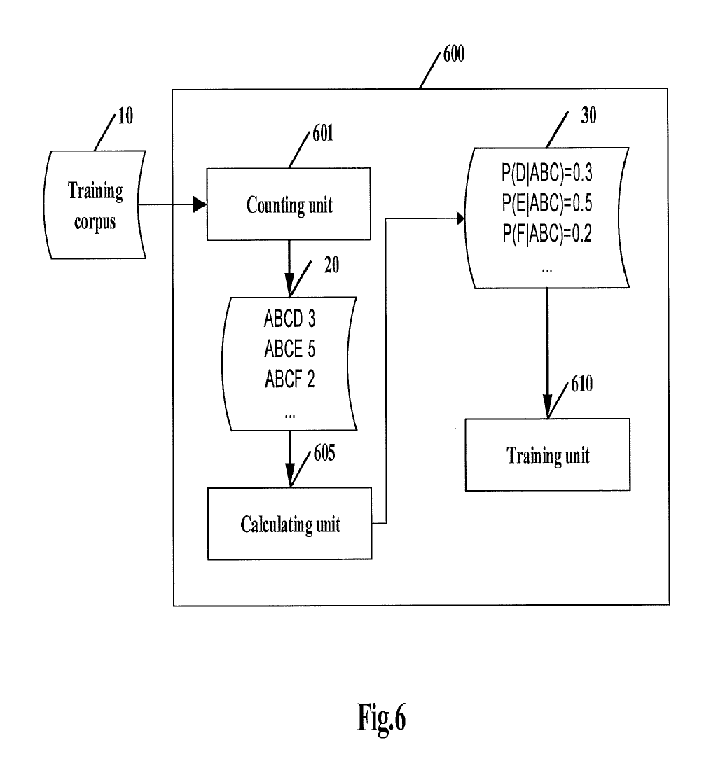

Next, an example of calculating probabilities of n-gram entries will be described in details with reference to FIG. 6. FIG. 6 is a block diagram of an example of an apparatus for training a neural network language model according to the third embodiment.

As shown in FIG. 6, the apparatus 600 for training a neural network language model includes a counting unit 601 that counts the times the n-gram entries occur in the training corpus 10 based on the training corpus 10. That is to say the times the n-gram entries occur in the training corpus 10 are counted and a count file 20 is obtained. In the count file 20, n-gram entries and occurrence times of the n-gram entries are recorded as below.
ABCD 3
ABCE 5
ABCF 2

The probabilities of the n-gram entries are calculated based on the number of n-grams and a probability distribution file 30 is obtained by the calculating unit 605. In the probability distribution file 30, n-gram entries and probabilities of the n-gram entries are recorded as below.
P(D|ABC)=0.3
P(E|ABC)=0.5
P(F|ABC)=0.2

The probabilities of the n-gram entries are calculated based on the count file 20, i.e. the count file 20 is converted into the probability distribution file 30 by the calculating unit 605. The calculating unit 605 includes a grouping unit and a normalizing unit.

The n-gram entries are grouped by the grouping unit according to inputs of the n-gram entries. The word sequence of the first n-1 words in the n-gram entry is an input of the neural network language model, which is “ABC” in the above example.

The probabilities of the n-gram entries are obtained by the normalizing unit by normalizing the occurrence times of output words with respect to each group. In the above example, there are 3 n-gram entries in the group of which the input is “ABC”. The times of the n-gram entries with output word of “D”, “E” and “F” are 3, 5 and 2 respectively. The total times are 10. The probabilities of the 3 n-gram entries can be obtained by normalizing, which are 0.3, 0.5 and 0.2. The probability distribution file 30 can be obtained by normalizing with respect to each group.

As shown in FIG. 5 and FIG. 6, the neural network language model is trained by the training unit 505 or the training unit 610 based on the n-gram entries and the probabilities of the n-gram entries, i.e. the probability distribution file 30.

The process of training the neural network language model based on the probability distribution file 30 will be described with reference to FIG. 3 in details below. FIG. 3 is a schematic diagram of a process of training a neural network language model according to the first embodiment.

As shown in FIG. 3, the word sequence of the first n-1 words of the n-gram entry is inputted into the input layer 301 of the neural network language model 300, and the output words of “D”, “E” and “F” and the probabilities of 0.3, 0.5 and 0.2 thereof are inputted into the output layer 303 of the neural network language model 300 as a training objective. The neural network language model 300 is trained by adjusting a parameter of the neural network language model 300. As shown in FIG. 3, the neural network language model 300 also includes hidden layers 302.

In the third embodiment, preferably, the neural network language model 300 is trained based on a minimum cross-entropy rule. That is to say, the difference between the real output and the training objective is decreased gradually until the model is converged.

Through the apparatus for training a neural network language model of the third embodiment, the original training corpus 10 is processed into the probability distribution file 30, the training speed of the model is up by training the model based on the probability distribution and the training becomes more efficient.

Moreover, through the apparatus for training a neural network language model of the third embodiment, the model performance is improved since optimization of the training objective is not local but global, so the training objective is more reasonable and the accuracy of the classification is much higher.

Moreover, through the apparatus for training a neural network language model of the third embodiment, implementation is easy and there is fewer modification for the model training process, only the input and output of training are modified and the final output of the model is not varied, so it is compatible with existing technology like distributed training.

Moreover, preferably, the apparatus for training a neural network language model of the third embodiment further includes a first filtering unit that filters an n-gram entry with the number of occurrences which is lower than a pre-set threshold after the n-grams in the training corpus 10 are counted by the counting unit.

Through the apparatus for training a neural network language model of the third embodiment, it is realized to compress the original training corpus by filtering n-gram entries with low occurrence times. Meanwhile, the noise of the training corpus is removed and the training speed of the model can be further up.

Moreover, preferably, the apparatus for training a neural network language model of the third embodiment further includes a second filtering unit that filters an n-gram entry based on an entropy rule after the probabilities of the n-gram entries are calculated by the calculating unit.

Through the apparatus for training a neural network language model of the third embodiment, the training speed of the model can be further up by filtering n-gram entries based on the entropy rule.

### <A Speech Recognition Apparatus>

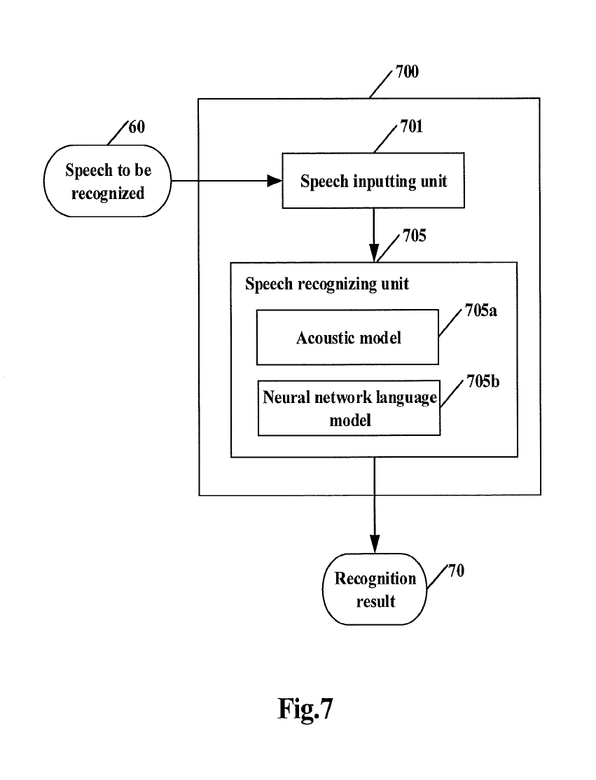

FIG. 7 is a block diagram of a speech recognition apparatus according to a fourth embodiment under a same inventive concept. Next, this embodiment will be described in conjunction with that figure. For those same parts as the above embodiments, the description of which will be properly omitted.

As shown in FIG. 7, the speech recognition apparatus 700 of the fourth embodiment comprising: a speech inputting unit 701 that inputs a speech 60 to be recognized; a speech recognizing unit 705 that recognizes the speech as a text sentence by using a neural network language model 705b trained by the above-mentioned apparatus for training the neural network language model and an acoustic model 705b.

In the fourth embodiment, the speech inputting unit 701 inputs a speech to be recognized. The speech to be recognized may be any speech and the embodiment has no limitation thereto.

The speech recognizing unit 705 recognizes the speech as a text sentence by using the neural network language model 705b and the acoustic model 705a.

An acoustic model and a language model are needed during recognition of the speech. In the fourth embodiment, the language model is a neural network language model trained by the above-mentioned apparatus for training the neural network language model, and the acoustic model may be any language model known in the art, which may be a neural network acoustic model or may be other type of acoustic model.

In the fourth embodiment, the method for recognizing a speech to be recognized by using a neural network language model and an acoustic model is any method known in the art, which will not be described herein for brevity.

Through the above speech recognition apparatus 700, the accuracy of the speech recognition can be increased by using a neural network language model trained by using the above-mentioned apparatus for training the neural network acoustic model.

Although a method for training a neural network language model, an apparatus for training a neural network language model, a speech recognition method and a speech recognition apparatus for the present embodiment have been described in detail through some exemplary embodiments, the above embodiments are not to be exhaustive, and various variations and modifications may be made by those skilled in the art within spirit and scope of the present invention. Therefore, the present invention is not limited to these embodiments, and the scope of which is only defined in the accompany claims.

What is claimed is:

1. An apparatus for training a neural network language model, comprising:
a calculating unit that calculates probabilities of n-gram entries based on a training corpus; and
a training unit that trains the neural network language model based on the n-gram entries and the probabilities of the n-gram entries.

2. The apparatus according to claim 1, further comprising:
a counting unit that counts the times the n-gram entries occur in the training corpus, based on the training corpus;
wherein the calculating unit calculates the probabilities of the n-gram entries based on the occurrence times of the n-gram entries.

3. The apparatus according to claim 2, further comprising:
a first filtering unit that filters an n-gram entry with an occurrence times which is lower than a pre-set threshold.

4. The apparatus according to claim 2, wherein
the calculating unit comprises
a grouping unit that groups the n-gram entries by inputs of the n-gram entries; and
a normalizing unit that obtains the probabilities of the n-gram entries by normalizing the occurrence times of output words with respect to each group.

5. The apparatus according to claim 2, further comprising:
a second filtering unit that filters an n-gram entry based on an entropy rule.

6. The apparatus according to claim 1, wherein
the training unit trains the neural network language model based on a minimum cross-entropy rule.

7. A speech recognition apparatus, comprising:
a speech inputting unit that inputs a speech to be recognized; and
a speech recognizing unit that recognizes the speech as a text sentence by using a neural network language model trained by using the apparatus according to claim 1 and an acoustic model.

8. A speech recognition apparatus, comprising:
a speech inputting unit that inputs a speech to be recognized; and
a speech recognizing unit that recognizes the speech as a text sentence by using a neural network language model trained by using the apparatus according to claim 2 and an acoustic model.

9. A method for training a neural network language model, comprising:
calculating probabilities of n-gram entries based on a training corpus; and
training the neural network language model based on the n-gram entries and the probabilities of the n-gram entries.

10. The method according to claim 9,
before the step of calculating probabilities of n-gram entries based on a training corpus, the method further comprising:
counting the times the n-gram entries occur in the training corpus, based on the training corpus;
wherein the step of calculating probabilities of n-gram entries based on a training corpus further comprises
calculating the probabilities of the n-gram entries based on the occurrence times of the n-gram entries.

11. A speech recognition method, comprising:
inputting a speech to be recognized; and
recognizing the speech as a text sentence by using a neural network language model trained by using the method according to claim 10 and an acoustic model.

12. A speech recognition method, comprising:
inputting a speech to be recognized; and
recognizing the speech as a text sentence by using a neural network language model trained by using the method according to claim 11 and an acoustic model.
